(19) United States
(12) Patent Application Publication
(10) Pub. No.: US 2010/0087542 A1
(43) Pub. Date: Apr. 8, 2010

(54) IMPROVEMENT OF THE BIOLOGICAL ACTION OF AGROCHEMICAL COMPOSITIONS WHEN APPLIED TO THE CULTIVATION SUBSTRATE, SUITABLE FORMULATIONS AND USE THEREOF

(75) Inventors: Udo Reckmann, Köln (DE); Peter Marczok, Koln (DE); Peter Baur, Schondorf (DE); Ronald Vermeer, Leverkusen (DE); Wolfgang Thielert, Odenthal (DE); Heike Hungenberg, Langenfeld (DE); Dirk Ebbinghaus, Wuppertal (DE); Peter Lösel, Leverkusen (DE)

Correspondence Address: Baker Donelson Bearman, Caldwell & Berkowitz, PC, 555 Eleventh Street, NW, Sixth Floor, Washington, DC, 20004, US

(73) Assignee: BAYER CROPSCIENCE AKTIENGESELLSHAFT, Monheim (DE)

(21) Appl. No.: 12/443,263

(22) PCT Filed: Sep. 18, 2007
(86) PCT No.: PCT/EP07/08096

§ 371 Date: Jun. 23, 2009

(30) Foreign Application Priority Data
Sep. 30, 2006 (EP) 06020678.6

(51) Int. Cl. A01N 37/18; A01P 7/04

(52) U.S. Cl. 514/616

(57) ABSTRACT

In soil application, the action of crop protection compositions comprising active compounds from the class of the insecticidal phthalic acid diamides can be improved by adjuvants. The present invention describes corresponding methods and suitable compositions.

The present invention relates to the improvement of the action of agrochemical compositions in soil applications, to agrochemical compositions suitable for this application and to their use for controlling harmful insects.

For controlling harmful organisms, agrochemically active compounds can be applied by various means. In addition to foliar treatment, it is also possible to treat the culture substrate. This may be soil, but also special substrates based, inter alia, on peat mosses, cocoa fibres, stone wool, such as, for example, Grodan®, pumice, expanded clay, such as, for example Lecaton® or Lecadan®, clay granules, such as, for example, Seramis®, foamed plastics, such as, for example, Baystrat®, vermiculite, perlite, synthetic soils, such as, for example, Hygromull®, or combinations of these substrates. Hereinbelow, all these culture substrates are referred to as soil. By applying active compounds in or onto the soil, soil-dwelling harmful organisms are brought into contact with the active compound, and the uptake of systemic active compounds by the roots is initiated. Various auxiliaries for improving the action of agrochemically active compounds in foliar treatment are already known. These include, for example, penetrants which facilitate the penetration of the active compounds into the plants (for example WO 03/000053). For soil applications of insecticides and fungicides, corresponding adjuvants have hitherto not been described. What is known is the effect of soil penetration aids which accelerate the penetration of irrigation water into dry soils (for example Agri-Prep® CS from Northwest Agricultural Products).

It is also known that surfactants may have an effect on the distribution of permethrin in the soil (Howell, McMullan P. M. (ed.), 1998, Adjuvants for Agrochemicals, Proceedings of the 5th international Symposium on Adjuvants for Agrochemicals, Memphis, USA, pp. 247-253).

Improvements of herbicidal compositions by optimized formulations have also been described (Chung et al., Pesticide Science, 1993, 38(2-3), pp. 250-252).

Surprisingly, it has now been found that the biological action of insecticidal compositions in soil applications can be improved when these compositions comprise an adjuvant. Here, the adjuvant may either already be a component of the concentrated formulation (in-can formulation), or it may be added during the preparation of the ready-to-use pesticide solution (tank mix application). The improved action is evident both in the control of soil organisms and in the control of foliar pests or foliar diseases controlled by the systemic active compounds. In this manner, using the compositions according to the invention, it is possible to decrease the amount of active compound applied or, at an unchanged application rate, to achieve improved action. Additionally, it is possible to reduce water consumption to a minimum.

Accordingly, the present invention provides for the use of adjuvants for improving the action of agrochemical compositions in soil applications, for example by spraying onto the soil, watering, side dressing, shower drenching, overhead drenching or application using an irrigation system (drip irrigation).

The present invention now provides novel suspension concentrates for this use comprising
at least one agrochemically active compound from the group of the insecticidal phthalic acid diamides which is solid at room temperature,
at least one adjuvant.

In addition to concentrated formulations, the invention also provides dilute ready-to-use compositions. The invention furthermore provides the use of these compositions for controlling harmful organisms in the soil and foliar pests.

In the context of the present invention, an adjuvant is a substance which, in the test system described below, improves the biological action:

Young maize plants are planted into 1 litre vessels with soil (sandy loam soil, humidity 10% by weight, pH 6.7). The plants are grown in a greenhouse at 20° C. for 3 or 12 days (until they have reached the 2- or 3-leaf stage) before they are watered. During watering, 0.25 mg or 0.5 mg of the insecticidally active compound (S)-3-chloro-N¹-{2-methyl-4-[1,2,2,2-tetrafluoro-1-(trifluoromethyl)ethyl]phenyl}N²-(1-methyl-2-methylsulphonylethyl)phthalamide (known from WO 06/22225) and 60 mg of potential adjuvant are applied in a watering volume of 60 ml. 1, 3, 7 or 14 days after watering, the plants are infected by populating them with larvae of the L2 stage of Spodoptera frugiperda, and the mortality of the larvae is determined in each case after 7 days. As a control, the same test is carried out without addition of a potential adjuvant. When the adjuvants according to the invention are used, this test shows a mortality which is increased compared to that of the control. Here, the mortality is not necessarily increased at each point of time, it may also be that only the initial activity or the long-term activity is improved.

Adjuvants according to the invention which may be mentioned as examples are in particular the following substances and compositions:
(I-1) dioctyl sodium sulphosuccinate, commercially available, for example, in the product series Geropon®,
(I-2) compositions comprising dioctyl sodium sulphosuccinate and sodium benzoate, commercially available, for example, in the product series Aerosol®; the weight ratio of dioctyl sodium sulphosuccinate:sodium benzoate is preferably from 5:1 to 6:1,
(I-3) terminally capped alkoxylated fatty alcohols and terminally capped alkoxylated straight-chain alcohols, commercially available, for example, in the product series Plurafac®; preference is given to ethoxylated and/or butoxylated fatty alcohols and terminally capped ethoxylated and/or butoxylated straight-chain alcohols,
(I-4) tributylphenol polyglycol ether having 10 to 15 EO units (where EO means ethylene oxide), commercially available, for example, in the product series Sapogenat®,
(I-5) polyalkylene oxide-modified polymethylsiloxanes, commercially available, for example, in the product series Silwet®,
(I-6) branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 (preferably from 8 to 12) and t and u are average values, commercially available, for example, in the product series Lutensol®,
(I-7) betaine,
(I-8) polyalkoxylated triglycerides, where the triglyceride is preferably of vegetable origin, commercially available, for example, in the product series Crovol®,
(I-9) alkoxylated fatty amines, commercially available, for example, in the product series Armoblen®,
(I-10) sodium laurethyl sulphate, commercially available, for example, in the product series Genapol®,
(I-11) PEG-10 coconut alcohol, commercially available, for example, in the product series Genapol®,
(I-12) compositions comprising maize syrup, methylated soya oil and nonionic emulsifier, commercially available, for example, in the product series Superb®.

Phthalic acid diamides are known as compounds having insecticidal properties (cf. EP-A-0 919 542, EP-A-1 006 107, WO 01/00 575, WO 01/00 599, WO 01/46 124, JP-A 2001-33 555 9, WO 01/02354, WO 01/21 576, WO 02/08 8074, WO 02/08 8075, WO 02/09 4765, WO 02/09 4766, WO 02/06 2807).

Such phthalic acid diamides are described by the formula (II):

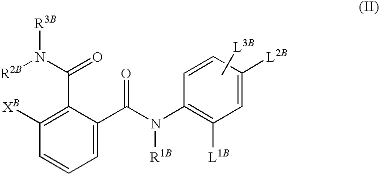

in which
X^{B} represents halogen, cyano, C₁-C₈-alkyl, C₁-C₈-haloalkyl, C₁-C₈-alkoxy or C₁-C₈-haloalkoxy,
R^{1B}, R^{2B} and R^{3B} independently of one another represent hydrogen, cyano, represent optionally halogen-substituted C₃-C₈-cycloalkyl or represent the group -M^{1B}-Q^{B}ₖ,
M^{1B} represents optionally substituted achiral C₁-C₁₂-alkylene, achiral C₃-C₁₂-alkenylene or achiral C₃-C₁₂-alkynylene,
Q^{B} represents hydrogen, halogen, cyano, nitro, C₁-C₈-haloalkyl, in each case optionally substituted C₃-C₈-cycloalkyl, C₁-C₈-alkyl-carbonyl or C₁-C₈-alkoxy-carbonyl, in each case optionally substituted phenyl, hetaryl or represents the group -T^{B}-R^{4B},
T^{B} represents oxygen, —S(O)ₘ— or —N(R^{5B})—,
R^{4B} represents hydrogen, in each case optionally substituted C₁-C₁₂-alkyl, C₃-C₁₂-alkenyl, C₃-C₁₂-alkynyl, C₃-C₈-cycloalkyl, C₃-C₈-cycloalkyl-C₁-C₆-alkyl, C₁-C₆-alkoxy-C₁-C₄-alkyl, C₁-C₈-alkyl-carbonyl, C₁-C₈-alkoxy-carbonyl, phenyl, phenyl-C₁-C₄-alkyl, phenyl-C₁-C₄-alkoxy, hetaryl, hetaryl-C₁-C₄-alkyl,
R^{5B} represents hydrogen, represents in each case optionally substituted C₁-C₈-alkyl-carbonyl, C₁-C₈-alkoxy-carbonyl, phenylcarbonyl or phenyl-C₁-C₆-alkoxy-carbonyl,
k represents 1, 2, 3, or 4,
m represents 0, 1 or 2,
R^{1B} and R^{2B} together form an optionally substituted 4- to 7-membered ring which may optionally be interrupted by heteroatoms,
L^{1B} and L^{3B} independently of one another represent hydrogen, halogen, cyano or in each case optionally substituted C₁-C₈-alkyl, C₁-C₈-alkoxy, C₁-C₆-alkyl-S(O)ₘ—, phenyl, phenoxy or hetaryloxy,
L^{2B} represents hydrogen, halogen, cyano, in each case optionally substituted C₁-C₁₂-alkyl, C₂-C₁₂-alkenyl, C₂-C₁₂-alkynyl, C₁-C₁₂-haloalkyl, C₃-C₈-cycloalkyl, phenyl, hetaryl or represents the group -M^{2B}-R^{6B},
M^{2B} represents oxygen or —S(O)ₘ—,
R^{6B} represents in each case optionally substituted C₁-C₈-alkyl, C₂-C₈-alkenyl, C₃-C₆-alkynyl, C₃-C₈-cycloalkyl, phenyl or hetaryl,
L^{1B} and L^{3B} or L^{1B} and L^{2B} in each case together form an optionally substituted 5- or 6-membered ring which may optionally be interrupted by heteroatoms.

The formula (II) provides a general definition of the phthalic acid diamides of the acaricidal and/or insecticidal compositions. Preferred substituents or ranges of radicals listed in the formulae mentioned above and below are illustrated below:
X^{B} preferably represents fluorine, chlorine, bromine, iodine, cyano, C₁-C₆-alkyl, C₁-C₆-haloalkyl, C₁-C₆-alkoxy or C₁-C₆-haloalkoxy.
R^{1B}, R^{2B} and R^{3B} independently of one another preferably represent hydrogen, cyano, represent optionally halogen-substituted C₃-C₆-cycloalkyl or represent the group -M^{1B}-Q^{B}ₖ,
M^{1B} preferably represents achiral C₁-C₈-alkylene, achiral C₃-C₆-alkenylene or achiral C₃-C₆-alkynylene.
Q^{B} preferably represents hydrogen, halogen, cyano, nitro, C₁-C₆-haloalkyl or represents optionally fluorine, chlorine, C₁-C₆-alkyl or C₁-C₆-alkoxy-substituted C₃-C₈-cycloalkyl in which optionally one or two not directly adjacent ring members are replaced by oxygen and/or sulphur or represents in each case optionally halogen-substituted C₁-C₆-alkyl-carbonyl or C₁-C₆-alkoxy-carbonyl or represents in each case optionally halogen-, C₁-C₆-alkyl-, C₁-C₆-haloalkyl-, C₁-C₆-alkoxy-, C₁-C₆-haloalkoxy-, cyano- or nitro-substituted phenyl or hetaryl having 5 or 6 ring atoms (for example furanyl, pyridyl, imidazolyl, triazolyl, pyrazolyl, pyrimidyl, thiazolyl or thienyl) or represents the group -T^{B}-R^{4B}.
T^{B} preferably represents oxygen, —S(O)ₘ— or —N(R^{5B})—.
R^{4B} preferably represents hydrogen, represents in each case optionally fluorine- and/or chlorine-substituted C₁-C₈-alkyl, C₃-C₈-alkenyl, C₃-C₈-alkynyl, C₃-C₈-cycloalkyl, C₃-C₈-cycloalkyl-C₁-C₂-alkyl, C₁-C₆-alkyl-carbonyl, C₁-C₆-alkoxy-carbonyl, represents phenyl, phenyl-C₁-C₄-alkyl, phenyl-C₁-C₄-alkoxy, hetaryl or hetaryl-C₁-C₄-alkyl, each of which is optionally mono- to tetra-substituted by halogen, C₁-C₆-alkyl, C₁-C₆-alkoxy, C₁-C₄-haloalkyl, C₁-C₄-haloalkoxy, nitro or cyano, where hetaryl has 5 or 6 ring atoms (for example furanyl, pyridyl, imidazolyl, triazolyl, pyrazolyl, pyrimidyl, thiazolyl or thienyl).
R^{5B} preferably represents hydrogen, represents in each case optionally fluorine- and/or chlorine-substituted C₁-C₆-alkyl-carbonyl, C₁-C₆-alkoxy-carbonyl, represents phenylcarbonyl or phenyl-C₁-C₄-alkyloxy-carbonyl, each of which is optionally mono to tetrasubstituted by halogen, C₁-C₆-alkyl, C₁-C₆-alkoxy, C₁-C₄-haloalkyl, C₁-C₄-haloalkoxy, nitro or cyano.
k preferably represents 1, 2 or 3.
m preferably represents 0, 1 or 2.
R^{1B} and R^{2B} together preferably form a 5- or 6-membered ring which may optionally be interrupted by an oxygen or sulphur atom.
L^{1B} and L^{3B} independently of one another preferably represent hydrogen, cyano, fluorine, chlorine, bromine, iodine, C₁-C₆-alkyl, C₁-C₄-haloalkyl, C₁-C₆-alkoxy, C₁-C₄-haloalkoxy, C₁-C₄-alkyl-S(O)ₘ—, C₁-C₄-haloalkyl-S(O)ₘ—, represent phenyl, phenoxy, pyridinyloxy, thiazolyloxy or pyrimidinyloxy, each of which is optionally mono- to trisubstituted by fluorine, chlorine, bromine, C₁-C₆-alkyl, C₁-C₆-alkoxy, C₁-C₄-haloalkyl, C₁-C₄-haloalkoxy, cyano or nitro.
L^{2B} preferably represents hydrogen, fluorine, chlorine, bromine, iodine, cyano, represents in each case optionally fluorine- and/or chlorine-substituted C₁-C₁₀-alkyl, C₂-C₁₀-alkenyl, C₂-C₆-alkynyl, represents in each case optionally fluorine-, chlorine-substituted C₃-C₆-cycloalkyl, represents phenyl, pyridinyl, thienyl, pyrimidyl or thiazolyl, each of which is optionally mono- to trisubstituted by fluorine, chlorine, bromine, C₁-C₆-alkyl, C₁-C₆-alkoxy, C₁-C₄-haloalkyl, C₁-C₄-haloalkoxy, cyano or nitro, or represents the group -M^{2B}-R^{6B}.
M^{2B} preferably represents oxygen or —S(O)ₘ—.
R^{6B} preferably represents in each case optionally fluorine- and/or chlorine-substituted C₁-C₈-alkyl, C₂-C₈-alkenyl, C₃-C₆-alkynyl or C₃-C₆-cycloalkyl, represents phenyl, pyridyl, pyrimidinyl or thiazolyl, each of which is optionally mono- to trisubstituted by fluorine, chlorine, bromine, C₁-C₆-alkyl, C₁-C₆-alkoxy, C₁-C₄-haloalkyl, C₁-C₄-haloalkoxy, cyano or nitro.
L^{1B} and L^{3B} or L^{1B} and L^{2B} in each case together preferably form a 5- or 6-membered ring which is optionally substituted by fluorine and/or C₁-C₂-alkyl and which may optionally be interrupted by one or two oxygen atoms.
X^{B} particularly preferably represents chlorine, bromine or iodine.
R^{1B}, R^{2B} and R^{3B} independently of one another particularly preferably represent hydrogen or represent the group -M^{1B}-Q^{B}ₖ.
M^{1B} particularly preferably represents achiral C₁-C₈-alkylene, achiral C₃-C₆-alkenylene or achiral C₃-C₆-alkynylene.
Q^{B} particularly preferably represents hydrogen, fluorine, chlorine, cyano, trifluoromethyl, C₃-C₆-cycloalkyl or represents the group -T^{B}-R^{4B}.
T^{B} particularly preferably represents oxygen or —S(O)ₘ—.
R^{4B} particularly preferably represents hydrogen, represents C₁-C₆-alkyl, C₃-C₆-alkenyl, C₃-C₆-alkynyl or C₃-C₆-cycloalkyl, each of which is optionally mono- to trisubstituted by fluorine and/or chlorine.
k particularly preferably represents 1, 2 or 3.
m particularly preferably represents 0, 1 or 2.
L^{1B} and L^{3B} independently of one another particularly preferably represent hydrogen, fluorine, chlorine, bromine, iodine, cyano, C₁-C₄-alkyl, C₁-C₂-haloalkyl, C₁-C₄-alkoxy, C₁-C₂-haloalkoxy, represent phenyl or phenoxy, each of which is optionally mono- or disubstituted by fluorine, chlorine, bromine, C₁-C₄-alkyl, C₁-C₄-alkoxy, C₁-C₂-haloalkyl, C₁-C₂-haloalkoxy, cyano or nitro.
L^{2B} particularly preferably represents hydrogen, fluorine, chlorine, bromine, iodine, cyano, represents C₁-C₆-alkyl, C₂-C₆-alkenyl, C₂-C₆-alkynyl, C₃-C₆-cycloalkyl, each of which is optionally mono- to tridecasubstituted by fluorine and/or chlorine, or represents the group -M^{2B}-R^{6B}.
M^{2B} particularly preferably represents oxygen or —S(O)ₘ—.
R^{6B} particularly preferably represents C₁-C₆-alkyl, C₂-C₆-alkenyl, C₂-C₆-alkynyl or C₃-C₆-cycloalkyl, each of which is optionally mono- to tridecasubstituted by fluorine and/or chlorine, represents phenyl or pyridyl, each of which is optionally mono- or disubstituted by fluorine, chlorine, bromine, C₁-C₄-alkyl, C₁-C₄-alkoxy, trifluoromethyl, difluoromethoxy, trifluoromethoxy, cyano or nitro.
X^{B} very particularly preferably represents iodine.
R^{1B} and R^{2B} very particularly preferably represent hydrogen.
R^{3B} very particularly preferably represents the group -M^{1B}-Q^{B}.
M^{1B} very particularly preferably represents —C(CH₃)₂CH₂— or —C(C₂H₅)₂CH₂—.
Q^{B} very particularly preferably represents hydrogen, fluorine, chlorine, cyano, trifluoromethyl, C₃-C₆-cycloalkyl or represents the group -T^{B}-R^{4B}.
T^{B} very particularly preferably represents —S—, —SO— or —SO₂—.
R^{4B} very particularly preferably represents methyl, ethyl, n-propyl, isopropyl, n-butyl, isobutyl, sec-butyl or tert-butyl, allyl, butenyl or isoprenyl, each of which is optionally mono- to trisubstituted by fluorine and/or chlorine.
L^{1B} and L^{3B} independently of one another very particularly preferably represent hydrogen, fluorine, chlorine, bromine, iodine, cyano, methyl, ethyl, n-propyl, isopropyl, tert-butyl, methoxy, ethoxy, trifluoromethyl, difluoromethoxy or trifluoromethoxy.
L^{2B} very particularly preferably represents hydrogen, fluorine, chlorine, bromine, iodine, cyano, represents methyl, ethyl, n-propyl, isopropyl, n-butyl, isobutyl, sec-butyl, tert-butyl, allyl, butenyl or isoprenyl, each of which is optionally mono- to nonasubstituted by fluorine and/or chlorine, or represents the group -M^{2B}-Q^{6B}.
M^{2B} very particularly preferably represents oxygen or sulphur.
R^{6B} very particularly preferably represents methyl, ethyl, n-propyl, isopropyl, n-butyl, isobutyl, sec-butyl, tert-butyl, allyl, butenyl or isoprenyl, each of which is optionally mono- to nonasubstituted by fluorine and/or chlorine, represents phenyl which is optionally mono- or disubstituted by fluorine, chlorine, bromine, methyl, ethyl, methoxy, trifluoromethyl, difluoromethoxy, trifluoromethoxy, cyano or nitro.

Specifically, particular mention may be made of the following compounds of the formula (II):

TABLE 1

| | |
|---|---|
| | (II) |
| 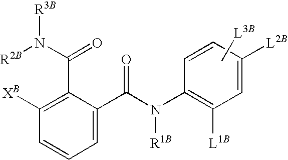 | |

| No. | X^{B} | R^{1B} | R^{2B} | R^{3B} | L^{1B} | L^{2B} | L^{3B} |
|---|---|---|---|---|---|---|---|
| II-1 | I | H | H | —C(CH₃)₂CH₂SCH₃ | CH₃ | iso- | H |
| | | | | | | C₃F₇ | |
| II-2 | I | H | H | —C(CH₃)₂CH₂SOCH₃ | CH₃ | iso- | H |
| | | | | | | C₃F₇ | |
| II-3 | I | H | H | —C(CH₃)₂CH₂SO₂CH₃ | CH₃ | iso- | H |
| | | | | | | C₃F₇ | |

In addition to at least one active compound and at least one adjuvant, the compositions according to the invention may preferably furthermore comprise further formulation auxiliaries:
at least one nonionic surfactant and/or at least one anionic surfactant
one or more additives from the groups of the antifreeze agents, the antifoams, the preservatives, the antioxidants, the spreading agents, the colorants and/or the thickeners.

Examples of further ingredients of the formulations according to the invention which may be mentioned are, in particular, the following substances:

Suitable nonionic surfactants are all compounds of this type which are usually employed in agrochemical compositions. Polyethylene oxide/polypropylene oxide block copolymers, polyethylene glycol ethers of straight-chain alcohols, reaction products of fatty acids or of ethylene oxide and/or propylene oxide, furthermore polyvinyl alcohol, polyvinylpyrrolidone, mixed polymers of polyvinyl alcohol and polyvinylpyrrolidone, mixed polymers of polyvinyl acetate and polyvinylpyrrolidone and also copolymers of (meth)acrylic acid and (meth)acrylic esters, furthermore alkyl ethoxylates and alkylaryl ethoxylates which may optionally be phosphated and may optionally be neutralized with bases, polyoxyamine derivatives and nonylphenol ethoxylates may be mentioned as being preferred.

Suitable anionic surfactants are all substances of this type which are usually employed in agrochemical compositions. Preference is given to alkali metal and alkaline earth metal salts of alkylsulphonic acids or alkylarylsulphonic acids.

A further preferred group of anionic surfactants or dispersants are salts of polystyrenesulphonic acids, salts of polyvinylsulphonic acids, salts of naphthalenesulphonic acid/formaldehyde condensates, salts of condensates of naphthalenesulphonic acid, phenolsulphonic acid and formaldehyde and also salts of lignosulphonic acid.

Suitable antifreeze agents are all substances of this type which are usually employed in agrochemical compositions. Preference is given to urea, glycerol, polyglycerol and polyglycerol derivatives, propanediol and propylene glycol.

Suitable antifoams are all substances usually employed for this purpose in agrochemical compositions. Preference is given to silicone oils and magnesium stearate.

Suitable preservatives are all substances of this type usually employed for this purpose in agrochemical compositions. Examples which may be mentioned are Preventol® (from Bayer AG) and Proxel®.

Suitable antioxidants are all substances which are usually employed for this purpose in agrochemical compositions. Examples which may be mentioned are: propyl gallate, octyl gallate, dodecyl gallate, butylated hydroxyanisole, propyl paraben, sodium benzoate, nordihydroguaiaretic acid and butylated hydroxytoluene. Preference is given to butylated hydroxytoluene (2,6-di-t-butyl-4-methylphenol, BHT).

Suitable spreaders are all substances which are usually employed for this purpose in agrochemical compositions. Preference is given to polyether- or organo-modified polysiloxanes.

Suitable colorants are all substances which are usually employed for this purpose in agrochemical compositions. Examples which may be mentioned are titanium dioxide, pigment-grade carbon black, zinc oxide and blue pigments and also permanent red FGR.

Suitable thickeners are all substances of this type which are usually employed in agrochemical compositions. Preference is given to silicates (such as, for example, Atagel® 50 from Engelhard) or xanthan gum (such as, for example, Kelzan® S from Kelko).

The concentrated formulations according to the invention are prepared by mixing the particular ratios desired of the components with one another. The components may be mixed with one another in any order. Expediently, the solid components are employed in a finely ground state. However, it is also possible to subject the suspension formed after mixing of the components initially to a coarse grinding and then than to a fine grinding so that the mean particle size is below 20 μm. Preferred are suspension concentrates in which the solid particles have a mean particle size of from 1 to 10 μm.

When carrying out the process according to the invention, the temperatures may be varied within a certain range. In general, the process is carried out at temperatures between 10° C. and 60° C., preferably between 15° C. and 40° C.

Suitable for carrying out the process according to the invention are customary mixers and grinders employed for producing agrochemical formulations.

The compositions according to the invention are formulations which are stable even after prolonged storage at elevated temperatures or in the cold, since no crystal growth is observed. By dilution with water, they can be converted into homogeneous spray liquors.

The application rate of the compositions according to the invention can be varied within a relatively wide range. It depends on the agrochemically active compounds in question and their content in the compositions.

Compositions according to the invention comprise
at least one active compound from the class of the insecticidal phthalic acid diamides and
at least one adjuvant.

In a preferred embodiment, compositions according to the invention comprise:
at least one active compound selected from the group consisting of (II-1), (II-2) and (II-3)
and at least one adjuvant.

In a particularly preferred embodiment, compositions according to the invention comprise:
at least one active compound selected from the group consisting of (II-1), (II-2) and (I-3).
and at least one substance or composition selected from the group consisting of (I-1) to (I-12)

The compositions according to the invention comprise—if they are concentrated formulations
generally from 1 to 60% by weight of one or more agrochemically active compounds which may be used according to the invention, preferably from 5 to 50% by weight and particularly preferably from 10 to 30% by weight,
generally from 1 to 50% by weight of at least one adjuvant according to the invention, preferably from 2 to 30% by weight and particularly preferably from 5 to 20% by weight,
generally from 1 to 20% by weight of nonionic surfactants and/or anionic surfactants, preferably from 2.5 to 10% by weight,
generally from 1 to 20% by weight of antifreeze agent, preferably from 5 to 15% by weight,
generally from 0.1 to 20% by weight of additives, preferably from 0.1 to 15% by weight.

The compositions according to the invention comprise—if they are ready-to-use formulations (solutions for watering)—generally from 0.05 to 10 g/l of adjuvant, preferably from 0.1 to 8 g/l and particularly preferably from 0.1 to 5 g/l.

Very particularly preferred concentrated formulations for soil applications comprise
from 1 to 60% by weight of at least one active compound selected from the group consisting of (II-1), (II-2) and (II-3)
between 1 and 50% by weight of at least one substance or composition selected from the group consisting of (I-1) to (I-12),
from 1 to 20% by weight of at least one nonionic surfactant and/or anionic surfactant,
from 1 to 20% by weight of antifreeze agent and
from 0.1 to 20% by weight of additives from the groups of the antifoams, the preservatives, the antioxidants, the spreading agents, the colorants and/or the thickeners.

In general, preference is given to certain combinations of active compounds and adjuvants listed in the table below, where each combination is preferred per se:

| | Active | |
|---|---|---|
| # | compound | Adjuvant |
| 1 | (II-1) | Dioctyl sodium sulphosuccinate |
| 2 | (II-1) | Compositions comprising dioctyl sodium sulphosuccinate and sodium |
| | | benzoate |
| 3 | (II-1) | Terminally capped alkoxylated fatty alcohols and terminally capped |
| | | alkoxylated straight-chain alcohols |
| 4 | (II-1) | Tributylphenol polyglycol ethers having 10 to 15 EO units |
| 5 | (II-1) | Polyalkylene oxide-modified polymethylsiloxanes |
| 6 | (II-1) | Branched alkanol alkoxylates of the formula |
| | | CH₃—(CH₂)ₜ—CH₂—O—(—CH₂—CH₂—O—)ᵤ—H, in which t represents numbers from |
| | | 9 to 10.5 and u represents numbers from 6 to 25 |
| 7 | (II-1) | Betaine |
| 8 | (II-1) | Polyalkoxylated triglycerides |
| 9 | (II-1) | Alkoxylated fatty amines |
| 10 | (II-1) | Sodium laurethyl sulphate |
| 11 | (II-1) | PEG-10 coconut alcohol |
| 12 | (II-1) | Compositions comprising maize syrup, methylated soya oil and nonionic |
| | | emulsifier |
| 13 | (II-2) | Dioctyl sodium sulphosuccinate |
| 14 | (II-2) | Compositions comprising dioctyl sodium sulphosuccinate and sodium |
| | | benzoate |
| 15 | (II-2) | Terminally capped alkoxylated fatty alcohols and terminally capped |
| | | alkoxylated straight-chain alcohols |
| 16 | (II-2) | Tributylphenol polyglycol ethers having 10 to 15 EO units |
| 17 | (II-2) | Polyalkylene oxide-modified polymethylsiloxanes |
| 18 | (II-2) | Branched alkanol alkoxylates of the formula |
| | | CH₃—(CH₂)ₜ—CH₂—O—(—CH₂—CH₂—O—)ᵤ—H, in which t represents numbers from |
| | | 9 to 10.5 and u represents numbers from 6 to 25 |
| 19 | (II-2) | Betaine |
| 20 | (II-2) | Polyalkoxylated triglycerides |
| 21 | (II-2) | Alkoxylated fatty amines |
| 22 | (II-2) | Sodium laurethyl sulphate |
| 23 | (II-2) | PEG-10 coconut alcohol |
| 24 | (II-2) | Compositions comprising maize syrup, methylated soya oil and nonionic |
| | | emulsifier |
| 25 | (II-3) | Dioctyl sodium sulphosuccinate |
| 26 | (II-3) | Compositions comprising dioctyl sodium sulphosuccinate and sodium |
| | | benzoate |
| 27 | (II-3) | Terminally capped alkoxylated fatty alcohols and terminally capped |
| | | alkoxylated straight-chain alcohols |
| 28 | (II-3) | Tributylphenol polyglycol ethers having 10 to 15 EO units |
| 29 | (II-3) | Polyalkylene oxide-modified polymethylsiloxanes |
| 30 | (II-3) | Branched alkanol alkoxylates of the formula |
| | | CH₃—(CH₂)ₜ—CH₂—O—(—CH₂—CH₂—O—)ᵤ—H, in which t represents numbers from |
| | | 9 to 10.5 and u represents numbers from 6 to 25 |
| 31 | (II-3) | Betaine |
| 32 | (II-3) | Polyalkoxylated triglycerides |
| 33 | (II-3) | Alkoxylated fatty amines |
| 34 | (II-3) | Sodium laurethyl sulphate |
| 35 | (II-3) | PEG-10 coconut alcohol |
| 36 | (II-3) | Compositions comprising maize syrup, methylated soya oil and nonionic |
| | | emulsifier |

Very particular preference is also given to ready-to-use compositions for soil applications which are obtained by diluting the concentrated solutions mentioned above.

The compositions of the invention, in combination with good plant tolerance, favourable toxicity to warm-blooded animals and high compatibility with the environment, are suitable for protecting plants and plant organs, for increasing the harvest yields, for improving the quality of the harvested material and for controlling animal pests, more particularly insects, arachnids, helminths, nematodes and molluscs, which are encountered in agriculture, in horticulture, in animal husbandry, in forests, in gardens and leisure facilities, in the protection of stored products and of materials, and in the hygiene sector. They may be preferably employed as crop protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is further possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticulitermes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

If appropriate, the compositions according to the invention can, at certain concentrations or application rates, also be used as herbicides, safeners, growth regulators or agents to improve plant properties, or as microbicides, for example as fungicides, antimycotics, bactericides, viricides (including agents against viroids) or as agents against MLO (Mycoplasma-like organisms) and RLO (Rickettsia-like organisms).

Compositions of the invention can in addition to abovementioned agrochemical active compounds comprise other active compounds as mixing partners, such as insecticides, attractants, sterilants, bactericides, acaricides, nematicides, fungicides, growth-regulating substances, herbicides, safeners, fertilizers or semiochemicals.

Particularly favourable mixing partners are, for example, the following components:

### Fungicides:

### Inhibitors of Nucleic Acid Synthesis

benalaxyl, benalaxyl-M, bupirimate, chiralaxyl, clozylacon, dimethirimol, ethirimol, furalaxyl, hymexazol, mefenoxam, metalaxyl, metalaxyl-M, ofurace, oxadixyl, oxolinic acid

### Inhibitors of Mitosis and Cell Division

benomyl, carbendazim, diethofencarb, ethaboxam, fuberidazole, pencycuron, thiabendazole, thiophanate-methyl, zoxamide

### Inhibitors of Respiratory Chain Complex I

diflumetorim

### Inhibitors of Respiratory Chain Complex II

boscalid, carboxin, fenfuram, flutolanil, furametpyr, furmecyclox, mepronil, oxycarboxin, penthiopyrad, thifluzamide

### Inhibitors of Respiratory Chain Complex III

azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin

### Decouplers

dinocap, fluazinam

### Inhibitors of ATP Production

fentin acetate, fentin chloride, fentin hydroxide, silthiofam

### Inhibitors of Amino Acid Biosynthesis and Protein Biosynthesis

andoprim, blasticidin-S, cyprodinil, kasugamycin, kasugamycin hydrochloride hydrate, mepanipyrim, pyrimethanil

### Inhibitors of Signal Transduction

fenpiclonil, fludioxonil, quinoxyfen

### Inhibitors of Lipid and Membrane Synthesis

chlozolinate, iprodione, procymidone, vinclozolin
ampropylfos, potassium-ampropylfos, edifenphos, etridiazole, iprobenfos (IBP), isoprothiolane, pyrazophos
tolclofos-methyl, biphenyl
iodocarb, propamocarb, propamocarb hydrochloride, propamocarb-fosetylate

### Inhibitors of Ergosterol Biosynthesis

fenhexamid,
azaconazole, bitertanol, bromuconazole, cyproconazole, diclobutrazole, difenoconazole, diniconazole, diniconazole-M, epoxiconazole, etaconazole, fenarimol, fenbuconazole, fluquinconazole, flurprimidole, flusilazole, flutriafol, furconazole, furconazole-cis, hexaconazole, imazalil, imazalil sulphate, imibenconazole, ipconazole, metconazole, myclobutanil, nuarimol, oxpoconazole, paclobutrazole, penconazole, pefurazoate, prochloraz, propiconazole, prothioconazole, pyrifenox, simeconazole, tebuconazole, tetraconazole, triadimefon, triadimenol, triflumizole, triforine, triticonazole, uniconazole, voriconazole, viniconazole,
aldimorph, dodemorph, dodemorph acetate, fenpropidin, fenpropimorph, spiroxamine,
tridemorph,
naftifine, pyributicarb, terbinafine

### Inhibitors of Cell Wall Synthesis

benthiavalicarb, bialaphos, dimethomorph, flumorph, iprovalicarb, mandipropamid, polyoxins, polyoxorim, validamycin A

### Inhibitors of Melanin Biosynthesis

capropamid, diclocymet, fenoxanil, phthalid, pyroquilon, tricyclazole

### Resistance Inductors

acibenzolar-S-methyl, probenazole, tiadinil

### Multisite

captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram

### Further Fungicides

amibromdol, benthiazole, bethoxazin, capsimycin, carvone, quinomethionate, chloropicrin, cufraneb, cyflufenamid, cymoxanil, dazomet, debacarb, diclomezine, dichlorophen, dicloran, difenzoquat, difenzoquat metilsulphate, diphenylamine, ferimzone, flumetover, flusulfamide, fluopicolide, fluoroimide, fosetyl-aluminium, fosetyl-calcium, fosetyl-sodium, hexachlorobenzene, 8-hydroxyquinoline sulphate, irumamycin, methasulfocarb, metrafenone, methyl isothiocyanate, mildiomycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyribencarb, pyrrolnitrin, quintozene, tecloftalam, tecnazene, triazoxide, trichlamide, valiphenal, zarilamid,
2-(2-{[6-(3-chloro-2-methylphenoxy)-5-fluoropyrimidin-4-yl]oxy}phenyl)-2-(methoxyimino)-N-methylacetamide,
2-[[[[1-[3-(1-fluoro-2-phenylethyl)oxy]phenyl]ethylidene]amino]oxy]methyl]-alpha-(methoxyimino)-N-methyl-alpha-benzacetamide,
cis-1-(4-chlorophenyl)-2-(1H-1,2,4-triazol-1-yl)cycloheptanol,
1-[(4-methoxyphenoxy)methyl]-2,2-dimethylpropyl-1H-imidazole-1-carboxylic acid,
2,3,5,6-tetrachloro-4-(methylsulphonyl)pyridine,
2-butoxy-6-iodo-3-propylbenzopyranon-4-one,
2-chloro-N-(2,3-dihydro-1,1,3-trimethyl-1H-inden-4-yl)-3-pyridinecarboxamide,
3,4,5-trichloro-2,6-pyridinedicarbonitrile,
3,4-dichloro-N-(2-cyanophenyl)isothiazole-5-carboxamide (isotianil)
3-[5-(4-chlorophenyl)-2,3-dimethylisoxazolidin-3-yl]pyridine,
5-chloro-6-(2,4,6-trifluorophenyl)-N-[(1R)-1,2,2-trimethylpropyl][1,2,4]triazolo[1,5-a]pyrimidine-7-amine,
5-chloro-7-(4-methylpiperidin-1-yl)-6-(2,4,6-trifluorophenyl)[1,2,4]triazolo[1,5-a]pyrimidine,
5-chloro-N-[(1R)-1,2-dimethylpropyl]-6-(2,4,6-trifluorophenyl) [1,2,4]triazolo[1,5-a]pyrimidine-7-amine,
methyl 2-[[[cyclopropyl[(4-methoxyphenyl)imino]methyl]thio]methyl]-alpha-(methoxymethylene)benzacetate,
methyl 1-(2,3-dihydro-2,2-dimethyl-1H-inden-1-yl)-1H-imidazole-5-carboxylate,
N-(3′,4′-dichloro-5-fluorobiphenyl-2-yl)-3-(difluoromethyl)-1-methyl-1H-pyrazole-4-carboxamide,
N-(3-ethyl-3,5,5-trimethylcyclohexyl)-3-formylamino-2-hydroxybenzamide,
N-(4-chloro-2-nitrophenyl)-N-ethyl-4-methylbenzenesulphonamide,
N-(4-chlorobenzyl)-3-[3-methoxy-4-(prop-2-yn-1-yloxy)phenyl]propanamide,
N-[(4-chlorophenyl)(cyano)methyl]-3-[3-methoxy-4-(prop-2-yn-1-yloxy)phenyl]propanamide,
N-(5-bromo-3-chloropyridin-2-yl)methyl-2,4-dichloronicotinamide,
N-[1-(5-bromo-3-chloropyridin-2-yl)ethyl]-2,4-dichloronicotinamide,
(2S)—N-[2-[4-[[3-(4-chlorophenyl)-2-propynyl]oxy]-3-methoxyphenyl]ethyl]-3-methyl-2-[(methylsulphonyl)amino]butanamide,
N-{(Z)-[(cyclopropylmethoxy)imino][6-(difluoromethoxy)-2,3-difluorophenyl]methyl}-2-benzacetamide,
N-{2-[1,1′-bi(cyclopropyl)-2-yl]phenyl}-3-(difluoromethyl)-1-methyl-1H-pyrazole-4-carboxamide,
N-{2-[3-chloro-5-(trifluoromethyl)pyridin-2-yl]ethyl}-2-(trifluoromethyl)benzamide,
N-ethyl-N-methyl-N′-{2-methyl-5-(trifluoromethyl)-4-[3-(trimethylsilyl)propoxy]phenyl}imidoformamide,
O-[1-[(4-methoxyphenoxy)methyl]-2,2-dimethylpropyl]-1H-imidazole-1-carbothioic acid,
2-amino-4-methyl-N-phenyl-5-thiazolecarboxamide,
2,4-dihydro-5-methoxy-2-methyl-4-[[[[1-[3-(trifluoromethyl)phenyl]ethylidene]amino]oxy]methyl]phenyl]-3H-1,2,4-triazol-3-one (CAS No. 185336-79-2),
N-(6-methoxy-3-pyridinyl)cyclopropane carboxamide,

### Bactericides:

bronopol, dichlorophen, nitrapyrin, nickel dimethyldithiocarbamate, kasugamycin, octhilinone, furancarboxylic acid, oxytetracycline, probenazole, streptomycin, tecloftalam, copper sulphate and other copper preparations.

### Insecticides/Acaricides/Nematicides:

### Acetylcholine Esterase (AChE) Inhibitors

Carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
Organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

### Sodium Channel Modulators/Voltage-Dependent Sodium Channel Blockers

Pyrethroids,
for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
DDT
Oxadiazines,
for example indoxacarb
Semicarbazone,
for example metaflumizon (BAS3201)

### Acetylcholine Receptor Agonists/Antagonists

Chloronicotinyls,
for example acetamiprid, clothianidin, dinotefuran, imidacloprid, nitenpyram, nithiazine, thiacloprid, thiamethoxam,
Nicotine, bensultap, cartap

### Acetylcholine Receptor Modulators

Spinosyns,
for example spinosad and spinetoram

### GABA-Controlled Chloride Channel Antagonists

Organochlorines,
for example camphechlor, chlordane, endosulfan, gamma-HCH, HCH, heptachlor, lindane, methoxychlor
Fiproles,
for example acetoprole, ethiprole, fipronil, pyrafluprole, pyriprole, vaniliprole

### Chloride Channel Activators

Mectins,
for example abamectin, emamectin, emamectin-benzoate, ivermectin, lepimectin, milbemycin

### Juvenile Hormone Mimetics,

for example diofenolan, epofenonane, fenoxycarb, hydroprene, kinoprene, methoprene, pyriproxifen, triprene

### Ecdysone Agonists/Disruptors

Diacylhydrazines,
for example chromafenozide, halofenozide, methoxyfenozide, tebufenozide

### Chitin Biosynthesis Inhibitors

Benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
Buprofezin
Cyromazine

### Oxidative Phosphorylation Inhibitors, ATP Disruptors

Diafenthiuron
Organotin compounds,
for example azocyclotin, cyhexatin, fenbutatin-oxide

### Oxidative Phosphorylation Decouplers Acting by Interrupting the H-Proton Gradient

Pyrroles,
for example chlorfenapyr
Dinitrophenols,
for example binapacryl, dinobuton, dinocap, DNOC, meptyldinocap

### Site-I Electron Transport Inhibitors

METI's,
for example fenazaquin, fenpyroximate, pyrimidifen, pyridaben, tebufenpyrad, tolfenpyrad
Hydramethylnon
Dicofol

### Site-II Electron Transport Inhibitors

Rotenone

### Site-III Electron Transport Inhibitors

Acequinocyl, fluacrypyrim

### Microbial Disruptors of the Insect Gut Membrane

Bacillus thuringiensis strains

### Lipid Synthesis Inhibitors

Tetronic acids,
for example spirodiclofen, spiromesifen
Tetramic acids,
for example spirotetramat, cis-3-(2,5-dimethylphenyl)-4-hydroxy-8-methoxy-1-azaspiro[4.5]dec-3-en-2-one
Carboxamides,
for example flonicamid
Octopaminergic agonists,
for example amitraz

### Inhibitors of Magnesium-Stimulated ATPase,

Propargite
Nereistoxin analogues,
for example thiocyclam hydrogen oxalate, thiosultap-sodium

### Ryanodine Receptor Agonists,

Benzodicarboxamides,
for example flubendiamide
Anthranilamides,
for example Rynaxypyr (3-bromo-N-{4-chloro-2-methyl-6-[(methylamino)carbonyl]-phenyl}-1-(3-chloropyridin-2-yl)-1H-pyrazole-5-carboxamide)

### Biologicals, Hormones or Pheromones

azadirachtin, Bacillus spec., Beauveria spec., codlemone, Metarrhizium spec., Paecilomyces spec., thuringiensin, Verticillium spec.
   Active Compounds with Unknown or Unspecific Mechanisms of Action
Fumigants,
for example aluminium phosphide, methyl bromide, sulphuryl fluoride
Antifeedants,
for example cryolite, flonicamid, pymetrozine
Mite growth inhibitors,
for example clofentezine, etoxazole, hexythiazox
Amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

A mixture with other known active compounds, such as herbicides, fertilizers, growth regulators, safeners, semiochemicals, or else with agents for improving the plant properties, is also possible.

When used as insecticides, the compositions according to the invention can furthermore be present in their commercially available formulations and in the use forms, prepared from these formulations, as a mixture with synergistic agents. Synergistic agents are compounds which increase the action of the active compounds present in the compositions according to the invention, without it being necessary for the synergistic agent added to be active itself.

When used as insecticides, the compositions according to the invention can furthermore be present in their commercially available formulations and in the use forms, prepared from these formulations, as a mixture with inhibitors which reduce degradation of the agrochemical active compound present after use in the environment of the plant, on the surface of parts of plants or in plant tissues.

The active compound content of the use forms prepared from the commercially available formulations can vary within wide limits. The active compound concentration of the use forms can be from 0.00000001 to 95% by weight of active compound, preferably between 0.00001 and 1% by weight.

The compounds are employed in a customary manner appropriate for the use forms.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds.

Treatment according to the invention of the plants and plant parts with the compositions is carried out by soil treatment.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering methods, if appropriate in combination with conventional methods

(Genetically Modified Organisms), and parts thereof are treated. The terms “parts”, “parts of plants” and “plant parts” have been explained above.

Particularly preferably, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. These can be cultivars, bio- or genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products are possible, which exceed the effects which were actually to be expected.

The transgenic plants or plant cultivars (obtained by genetic engineering) which are preferably to be treated according to the invention include all plants which, by virtue of the genetic modification, received genetic material which imparted particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, higher quality and/or a higher nutritional value of the harvested products, better storage stability and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, sugar beet, tomatoes, peas and other vegetable varieties, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are emphasized are in particular increased defence of the plants against insects, arachnids, nematodes and slugs and snails by virtue of toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (referred to hereinbelow as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plant cultivars will be developed and/or marketed in the future.

The plants listed can be treated according to the invention in a particularly advantageous manner with the compositions according to the invention. The preferred ranges stated above for the compositions also apply to the treatment of these plants. Particular emphasis is given to the treatment of plants with the compositions specifically mentioned in the present text.

The compositions according to the invention act not only against plant, hygiene and stored product pests, but also in the veterinary medicine sector against animal parasites (ecto- and endoparasites), such as hard ticks, soft ticks, mange mites, leaf mites, flies (biting and licking), parasitic fly larvae, lice, hair lice, feather lice and fleas. These parasites include:

From the order of the Anoplurida, for example, Haematopinus spp., Linognathus spp., Pediculus spp., Phtirus spp., Solenopotes spp.

From the order of the Mallophagida and the suborders Amblycerina and Ischnocerina, for example, Trimenopon spp., Menopon spp., Trinoton spp., Bovicola spp., Werneckiella spp., Lepikentron spp., Damalina spp., Trichodectes spp., Felicola spp.

From the order of the Diptera and the suborders Nematocerina and Brachycerina, for example, Aedes spp., Anopheles spp., Culex spp., Simulium spp., Eusimulium spp., Phlebotomus spp., Lutzomyia spp., Culicoides spp., Chrysops spp., Hybomitra spp., Atylotus spp., Tabanus spp., Haematopota spp., Philipomyia spp., Braula spp., Musca spp., Hydrotaea spp., Stomoxys spp., Haematobia spp., Morellia spp., Fannia spp., Glossina spp., Calliphora spp., Lucilia spp., Chrysomyia spp., Wohlfahrtia spp., Sarcophaga spp., Oestrus spp., Hypoderma spp., Gasterophilus spp., Hippobosca spp., Lipoptena spp., Melophagus spp.

From the order of the Siphonapterida, for example, Pulex spp., Ctenocephalides spp., Xenopsylla spp., Ceratophyllus spp.

From the order of the Heteropterida, for example, Cimex spp., Triatoma spp., Rhodnius spp., Panstrongylus spp.

From the order of the Blattarida, for example, Blatta orientalis, Periplaneta americana, Blattela germanica, Supella spp.

From the subclass of the Acari (Acarina) and the orders of the Meta- and Mesostigmata, for example, Argas spp., Ornithodorus spp., Otobius spp., Ixodes spp., Amblyomma spp., Boophilus spp., Dermacentor spp., Haemophysalis spp., Hyalomma spp., Rhipicephalus spp., Dermanyssus spp., Raillietia spp., Pneumonyssus spp., Sternostoma spp., Varroa spp.

From the order of the Actinedida (Prostigmata) and Acaridida (Astigmata), for example, Acarapis spp., Cheyletiella spp., Ornithocheyletia spp., Myobia spp., Psorergates spp., Demodex spp., Trombicula spp., Listrophorus spp., Acarus spp., Tyrophagus spp., Caloglyphus spp., Hypodectes spp., Pterolichus spp., Psoroptes spp., Chorioptes spp., Otodectes spp., Sarcoptes spp., Notoedres spp., Knemidocoptes spp., Cytodites spp., Laminosioptes spp.

The compositions according to the invention are also suitable for controlling arthropods which infest agricultural productive livestock, such as, for example, cattle, sheep, goats, horses, pigs, donkeys, camels, buffalo, rabbits, chickens, turkeys, ducks, geese and bees, other pets, such as, for example, dogs, cats, caged birds and aquarium fish, and also so-called test animals, such as, for example, hamsters, guinea pigs, rats and mice. By controlling these arthropods, cases of death and reduction in productivity (for meat, milk, wool, hides, eggs, honey etc.) should be diminished, so that more economic and easier animal husbandry is possible by use of the compositions according to the invention.

The compositions according to the invention are used in the veterinary sector and in animal husbandry in a known manner by enteral administration in the form of, for example, tablets, capsules, potions, drenches, granules, pastes, boluses, the feed-through process and suppositories, by parenteral administration, such as, for example, by injection (intramuscular, subcutaneous, intravenous, intraperitoneal and the like), implants, by nasal administration, by dermal use in the form, for example, of dipping or bathing, spraying, pouring on and spotting on, washing and powdering, and also with the aid of moulded articles containing the active compound, such as collars, ear marks, tail marks, limb bands, halters, marking devices and the like.

When used for cattle, poultry, pets and the like, the compositions can be used as formulations (for example powders, emulsions, free-flowing compositions), which comprise the active compounds in an amount of 1 to 80% by weight, directly or after 100 to 10 000-fold dilution, or they can be used as a chemical bath.

It has furthermore been found that the compositions according to the invention also have a strong insecticidal action against insects which destroy industrial materials.

The following insects may be mentioned as examples and as preferred—but without any limitation:

Beetles, such as Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus;

Hymenopterons, such as Sirex juvencus, Urocerus gigas, Urocerus gigas taignus, Urocerus augur;

Termites, such as Kalotermes flavicollis, Cryptotermes brevis, Heterotermes indicola, Reticulitermes flavipes, Reticulitermes santonensis, Reticulitermes lucifugus, Mastotermes darwiniensis, Zootermopsis nevadensis, Coptotermes formosanus;

Bristletails, such as Lepisma saccharina.

Industrial materials in the present connection are to be understood as meaning non-living materials, such as, preferably, plastics, adhesives, sizes, papers and cardboards, leather, wood and processed wood products and coating compositions.

The ready-to-use compositions may, if appropriate, comprise further insecticides and, if appropriate, one or more fungicides.

With respect to possible additional additives, reference may be made to the insecticides and fungicides mentioned above.

The compositions according to the invention can likewise be employed for protecting objects which come into contact with saltwater or brackish water, such as hulls, screens, nets, buildings, moorings and signalling systems, against fouling.

Furthermore, the compositions according to the invention, alone or in combination with other active compounds, may be employed as antifouling agents.

In domestic, hygiene and stored-product protection, the compositions are also suitable for controlling animal pests, in particular insects, arachnids and mites, which are found in enclosed spaces such as, for example, dwellings, factory halls, offices, vehicle cabins and the like. They can be employed alone or in combination with other active compounds and auxiliaries in domestic insecticide products for controlling these pests. They are active against sensitive and resistant species and against all developmental stages. These pests include:

From the order of the Scorpionidea, for example, Buthus occitanus.

From the order of the Acarina, for example, Argas persicus, Argas reflexus, Bryobia ssp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Dermaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Pemphigus spp., Phylloera vastatrix, Phthirus pubis.

From the order of the Heteroptera, for example, Cimex hemipterus, Cimex lectularius, Rhodinus prolixus, Triatoma infestans.

In the field of household insecticides, they are used alone or in combination with other suitable active compounds, such as phosphoric esters, carbamates, pyrethroids, neonicotinoids, growth regulators or active compounds from other known classes of insecticides.

According to S. R. Colby, Weeds 15 (1967), 20-22 the expected activity for a given combination of two active compounds can be calculated as follows:

If
X is the kill rate, expressed in % of the untreated control, when employing the active compound A at an application rate of m g/ha or in a concentration of m ppm,
Y is the kill rate, expressed in % of the untreated control, when employing the active compound B at an application rate of n g/ha or a concentration of n ppm and
E is the kill rate, expressed in % of the untreated control, when employing active compounds A and B at application rates of m and n g/ha or in a concentration of m and n ppm,
   then

$$E = X + Y - \frac{X \cdot Y}{100}$$

If the actual kill rate is higher than the calculated one, the kill rates of the combination are superadditive, i.e. a synergistic effect is present. In this case, the kill rate that is actually observed has to be higher than the value, calculated using the formula above, for the expected kill rate (E).

### EXAMPLE A

### Spodoptera frugiperda

### Test To produce a suitable solution of product, 1 part by weight of formulated product is mixed with water to the desired concentration. The desired adjuvant is added in a defined amount and mixed well.

Corn plants (Zea mays) are watered with the product solution of the desired concentration and infected with larvae of the army worm (Spodoptera frugiperda).

After the desired period of time, the kill in % is determined 100% means that all caterpillars have been killed; 0% means that none of the caterpillars have been killed. The kill rates determined are entered into Colby's formula (see sheet 1).

In this test, for example, the following combinations of active compound and adjuvant in accordance with the present application show a synergistically enhanced activity compared to the active compounds applied on their own:

TABLE A1
Plant-damaging insects

| | Concentration in mg | Kill in % | |
|---|---|---|---|
| | of ai or product per | 4 days after | |
| Active compound | liter of soil | infection | |
| AMSI 254 SC 120 | 1.0 | 20 | |
| | 0.5 | 7 | |
| Aerosol ® OT-B | 2000 | 0 | |
| | | found* | calc.** |
| AMSI 254 SC 120 + | 1.0 + 2000 | 100 | 20 |
| Aerosol ® OT-B | 0.5 + 2000 | 83 | 7 |
| according to the invention | | | |
| Agrimul ® RSO 1503 | 2000 | 0 | |
| | | found* | calc.** |
| AMSI 254 SC 120 + | 1.0 + 2000 | 63 | 20 |
| Agrimul ® RSO 1503 | | | |
| according to the invention | | | |
| Emulan ® HE 50 | 2000 | 0 | |
| | | found* | calc.** |
| AMSI 254 SC 120 + | 1.0 + 2000 | 47 | 20 |
| Emulan ® HE 50 | | | |
| according to the invention | | | |
| Plurafac ® LF 231 | 2000 | 20 | |
| | | found* | calc.** |
| AMSI 254 SC 120 + | 1.0 + 2000 | 97 | 36 |
| Plurafac ® LF 231 | 0.5 + 2000 | 98 | 25.6 |
| according to the invention | | | |
| Silwett ® L 77 | 2000 | 0 | |
| | | found* | calc.** |
| AMSI 254 SC 120 + | 1.0 + 2000 | 93 | 20 |
| Silwett ® L 77 | 0.5 + 2000 | 67 | 7 |
| according to the invention | | | |
| Surfynol ® TG | 2000 | 0 | |
| | | found* | calc.** |
| AMSI 254 SC 120 + | 1.0 + 2000 | 65 | 20 |
| Surfynol ® TG | 0.5 + 2000 | 60 | 7 |
| according to the invention | | | |
| Witconol ® NS 500 LQ | 2000 | 0 | |
| | | found* | calc.** |
| AMSI 254 SC 120 + | 1.0 + 2000 | 83 | 20 |
| Witconol ® NS 500 LQ | | | |
| according to the invention | | | |

Spodoptera frugiperda test, infection 3 days after drench application
*found = activity found
**calc. = activity calculated using Colby's formula

TABLE A2
Plant-damaging insects
Spodoptera frugiperda test, infection 5 days after drench application

| | Concentration in mg of ai | Kill in % 4 days | |
|---|---|---|---|
| Active compound | or product per liter of soil | after infection | |
| AMSI 254 SC 120 | 1.0 | 70 | |
| | 0.5 | 33 | |
| Imbentin ® AG S 90 | 2000 | 17 | |
| | | found* | calc.** |
| AMSI 254 SC 120 + | 1.0 + 2000 | 99 | 5.17 |
| Imbentin ® AG S 90 | | | |
| according to the | 0.5 + 2000 | 65 | 44.39 |
| invention | | | |

*found = activity found
**calc. = activity calculated using Colby's formula

1. A method for controlling animal pests comprising applying an agrochemical composition comprising at least one agrochemically active compound from the class of the insecticidal phthalic acid diamides to the culture substrate of a plant, and applying at least one adjuvant to said culture substrate.

2. A method according to claim 1, wherein the adjuvant is selected from the group consisting of
dioctyl sodium sulphosuccinate,
compositions comprising dioctyl sodium sulphosuccinate and sodium benzoate,
terminally capped alkoxylated fatty alcohols and terminally capped alkoxylated straight-chain alcohols,
tributylphenol polyglycol ethers having 10 to 15 EO units, where EO means ethylene oxide,
polyalkylene oxide-modified polymethylsiloxanes,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25,
betaine,
polyalkoxylated triglycerides,
alkoxylated fatty amines,
sodium laurethyl sulphate,
PEG-10 coconut alcohol and
compositions comprising maize syrup, methylated soya oil and nonionic emulsifier.

3. An agrochemical composition for use in the soil, comprising
at least one agrochemically active compound from the class of the insecticidal phthalic acid diamides,
at least one adjuvant selected from the group consisting of
dioctyl sodium sulphosuccinate,
compositions comprising dioctyl sodium sulphosuccinate and sodium benzoate
terminally capped alkoxylated fatty alcohols and terminally capped alkoxylated straight-chain alcohols
tributylphenol polyglycol ethers having 10 to 15 EO units, where EO means ethylene oxide,
polyalkylene oxide-modified polymethylsiloxanes,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25,
betaine,
polyalkoxylated triglycerides,
alkoxylated fatty amines,
sodium laurethyl sulphate,
PEG-10 coconut alcohol and
compositions comprising maize syrup, methylated soya oil and nonionic emulsifier.

4. A composition according to claim 3, comprising
at least one nonionic surfactant and/or at least one anionic surfactant,
at least one additive selected from the group consisting of antifreeze agents, antifoams, preservatives, antioxidants, spreading agents, colorants and/or thickeners.

5. A composition according to claim 4, comprising
from 1 to 60% by weight of at least one agrochemically active compound from the class of the insecticidal phthalic acid diamides,
from 1 to 50% by weight of at least one adjuvant,
from 1 to 20% by weight of at least one nonionic surfactant and/or anionic surfactant,
from 1 to 20% by weight of antifreeze agent and
from 0.1 to 20% by weight of said at least one additive.

6. A composition according to claim 3 comprising at least one active compound selected from the group consisting of (II-1), (II-2), and (II-3)

| | |
|---|---|
| | (II) |
| 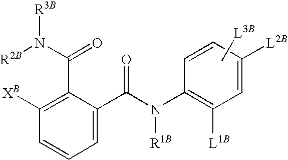 | |
| No. | X^{B} | R^{1B} | R^{2B} | R^{3B} | L^{1B} | L^{2B} | L^{3B} |
|---|---|---|---|---|---|---|---|
| II-1 | I | H | H | —C(CH₃)₂CH₂SCH₃ | CH₃ | iso- | H |
| | | | | | | C₃F₇ | |
| II-2 | I | H | H | —C(CH₃)₂CH₂SOCH₃ | CH₃ | iso- | H |
| | | | | | | C₃F₇ | |
| II-3 | I | H | H | —C(CH₃)₂CH₂SO₂CH₃ | CH₃ | iso- | H |
| | | | | | | C₃F₇ | |

7. A method for improving the action of crop protection agents comprising at least one active compound from the class of the insecticidal phthalic acid diamides in soil applications, wherein said method comprises applying said at least one adjuvant to soil.

8. A method according to claim 7, wherein said at least one adjuvant is selected from the group consisting of
dioctyl sodium sulphosuccinate,
compositions comprising dioctyl sodium sulphosuccinate and sodium benzoate,
terminally capped alkoxylated fatty alcohols and terminally capped alkoxylated straight-chain alcohols,
tributylphenol polyglycol ethers having 10 to 15 EO units, where EO means ethylene oxide,
polyalkylene oxide-modified polymethylsiloxanes,
branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25,
betaine,
polyalkoxylated triglycerides,
alkoxylated fatty amines,
sodium laurethyl sulphate,
PEG-10 coconut alcohol and
compositions comprising maize syrup, methylated soya oil and nonionic emulsifier.

9. A composition according to claim 4 comprising at least one active compound selected from the group consisting of (II-1), (II-2), and (II-3)

| | |
|---|---|
| | (II) |
| 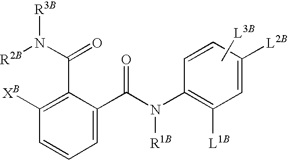 | |
| No. | X^{B} | R^{1B} | R^{2B} | R^{3B} | L^{1B} | L^{2B} | L^{3B} |
|---|---|---|---|---|---|---|---|
| II-1 | I | H | H | —C(CH₃)₂CH₂SCH₃ | CH₃ | iso- | H |
| | | | | | | C₃F₇ | |
| II-2 | I | H | H | —C(CH₃)₂CH₂SOCH₃ | CH₃ | iso- | H |
| | | | | | | C₃F₇ | |
| II-3 | I | H | H | —C(CH₃)₂CH₂SO₂CH₃ | CH₃ | iso- | H |
| | | | | | | C₃F₇ | |

10. A composition according to claim 5, comprising at least one active compound selected from the group consisting of (II-1), (II-2), and (II-3)

| | |
|---|---|
| | (II) |
| 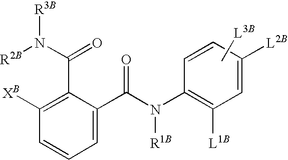 | |
| No. | X^{B} | R^{1B} | R^{2B} | R^{3B} | L^{1B} | L^{2B} | L^{3B} |
|---|---|---|---|---|---|---|---|
| II-1 | I | H | H | —C(CH₃)₂CH₂SCH₃ | CH₃ | iso- | H |
| | | | | | | C₃F₇ | |
| II-2 | I | H | H | —C(CH₃)₂CH₂SOCH₃ | CH₃ | iso- | H |
| | | | | | | C₃F₇ | |
| II-3 | I | H | H | —C(CH₃)₂CH₂SO₂CH₃ | CH₃ | iso- | H |
| | | | | | | C₃F₇ | |
